(19) United States
(12) Patent Application Publication
(10) Pub. No.: US 2008/0062396 A1
(43) Pub. Date: Mar. 13, 2008

(54) AUTO FOCUS SYSTEM

(76) Inventor: Kyung-Rok Ryu, Seoul (KR)

Correspondence Address: SHERR & NOURSE, PLLC, 620 HERNDON PARKWAY, SUITE 200, HERNDON, VA, 20170, US

(21) Appl. No.: 11/849,695

(22) Filed: Sep. 4, 2007

(30) Foreign Application Priority Data
Sep. 12, 2006 (KR) 10-2006-0087748

(51) Int. Cl. G03B 27/70; G03B 27/52

(52) U.S. Cl. 355/60; 355/63

(57) ABSTRACT

Embodiments relate to a wafer stage moved in all directions by means of an actuator. A wafer holder installed on the upper side of the wafer stage mounts a wafer on the wafer stage. An auto focus sensor block measures the focus simultaneously with exposure of the wafer using auto focus sensors. A piezo may be positioned on the upper surface of the wafer holder, including pins corresponding to the auto focus sensors and capable of moving the wafer up and down by driving the pins using defocusing data from the auto focus sensor block. Focus control units are provided at equal distances on the outer surface of the wafer holder to drive the wafer holder up and down. A light source system provided at one side of the wafer stage irradiates light over the wafer. A reflective mirror is provided below the light source system to direct light to the wafer. A reticle passes the light so that a pattern is fixed over the wafer by the light irradiated from the light source.

The present application claims priority under 35 U.S.C. 119 to Korean Patent Application No. 10-2006-0087748, filed on Sep. 12, 2006, which is hereby incorporated by reference in its entirety.

### BACKGROUND

In a process for fabricating a semiconductor device on a wafer, a variety of methods for forming a circuit in a stacked manner, or forming a desired pattern through a photolithography process may be used.

In the photolithography process, there may be a surface treatment process for maximizing the adhesion of a wafer surface. There may be an organic anti-reflection coating. Drying and dehydration processes may be performed prior to coating a photo resist so that when hydrophobing and developing the surface with stacked layers, the patterns do not come off. After increasing the adhesion with surface treatment processes, the particles on the surface may be removed using a thinner, and the photo resist may be coated.

After removing solvent components present on the resist through a soft bake process, a mask having a circuit of a desired pattern may be selectively exposed according to the wavelength of an exposure device. A post-exposure bake process may be used with possibly different effects depending on whether the resist is an I-line resist or a deep ultraviolet (DUV) resist. The post-exposure bake process in the I-line resist may be performed to minimize a standing wave effect. The post-exposure bake process in the DUV resist can be an important process in forming a desired line width.

After a bake process, the ID and edge of the water are selectively exposed, and the photo resist may be removed in a development process. All portions of the photo resist except for the portion where a real pattern will be formed, are removed through this development process. After the development process, the bake process can be added or removed according to the patterns. The main object of a lithography may be to shape a pattern having an accurate size at an accurate position. To ascertain whether the pattern is well executed, with a specified pattern size and shape, a critical dimension (CD) may be measured with a scanning electron microscope (SEM). An overlay measurement may be made in order to ascertain overlay accuracy between an existing formed layer and a layer to be formed.

The overlay margin may be somewhat different according to the critical dimension and the layout of a cell, however, is generally set at about 30% of the CD. The degree of overlay may be expressed by measuring deviated degrees as compared to the existing layer in several portions of the substrate and indicating them in a form of mean +3 sigma. A focus control system may automatically or manually select auto focus sensors arranged according to a scan direction to read data on the surface of a transformed wafer through a sensor so that driving of three ZT units up and down is controlled.

However, a problem with this control method is that compensation for defocus due to a particle or a deflection of the edge of the wafer, along with the position and control of the unit disposed in a triangle at three portions of a wafer holder is not effective, and reduces yield.

In an auto focus system according to the related art, three focus control units are installed at equal distances on the bottom surface of the wafer holder in order to finely control the wafer. Read data values are fed back to an auto focus sensor by the movement of the focus control units, thereby compensating for a step on the wafer surface. However, the problem with using this type of focus control unit is that it has a structure vulnerable to compensate for the local defocus within a shot or at the edge of the wafer.

In a case where forty five auto focus sensors are disposed and automatically set, nine auto focus sensors are selected to be fitted to shot sizes so that focusing in a shot can be performed. In the case of an edge shot they are forcibly manually set so that the focusing can be performed. The nine sensors are disposed in a check shape, and the sensor of a first line according to the scan direction serves as a proceeding sensor and performs a focus before entering an exposure field. As a result, data are fed back to the following sensors of two following lines to raise the focusing reaction speed of the following sensors. At the same time, the focus is measured simultaneously with exposure. The measurement data are transferred to a controller so that the focus control unit is driven up and down as measured depending on the focus state of a corresponding shot, and adjusts focus and leveling to allow a pattern to be correctly formed.

That is, the auto focus system according to the related art transfers the data for the distortion of the wafer surface received from a designated auto focus sensor to the focus control units disposed in the triangle shape on the bottom surface of the water holder. Each of the focus control units is driven in three dimensions to be adjusted to positions, thereby controlling the global leveling and the focus in the shot.

Therefore, since it does not effectively cope with the defocus due to the particle attached to the edge portion or the back surface of the wafer, the yield is compromised.

### SUMMARY

Embodiments relate to an auto focus system capable of forming a pattern by irradiating light, and more specifically relates to an auto focus system capable of improving the yield of a wafer by finely adjusting the wafer using a piezo. The system may be used to efficiently remove local defocusing over a wafer and defocusing due to a step at the edge of the water. Embodiments relate to an auto focus system capable of improving the yield of a wafer by finely adjusting the wafer using a piezo to efficiently correct a local defocus over a wafer and a defocus due to a step at the edge of the wafer.

Embodiments relate to a wafer stage moved in all directions by means of an actuator. A wafer holder installed on the upper side of the wafer stage mounts a wafer on the wafer stage. An auto focus sensor block measures the focus simultaneously with exposure of the wafer using auto focus sensors. A piezo may be positioned on the upper surface of the wafer holder, including pins corresponding to the auto focus sensors and capable of moving the wafer up and down by driving the pins using defocusing data from the auto focus sensor block. Focus control units are provided at equal distances on the outer surface of the wafer holder to drive the wafer holder up and down. A light source system provided at one side of the wafer stage irradiates light over the wafer. A reflective mirror is provided below the light source system to direct light to the wafer. A reticle passes the light so that a pattern is fixed over the wafer by the light irradiated from the light source.

### DRAWINGS

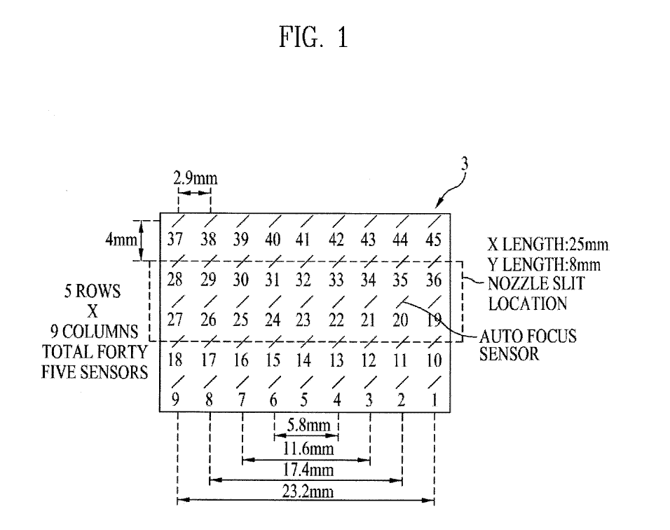

Example FIG. 1 is a schematic view showing an auto focus sensor of an auto focus system according to embodiments.

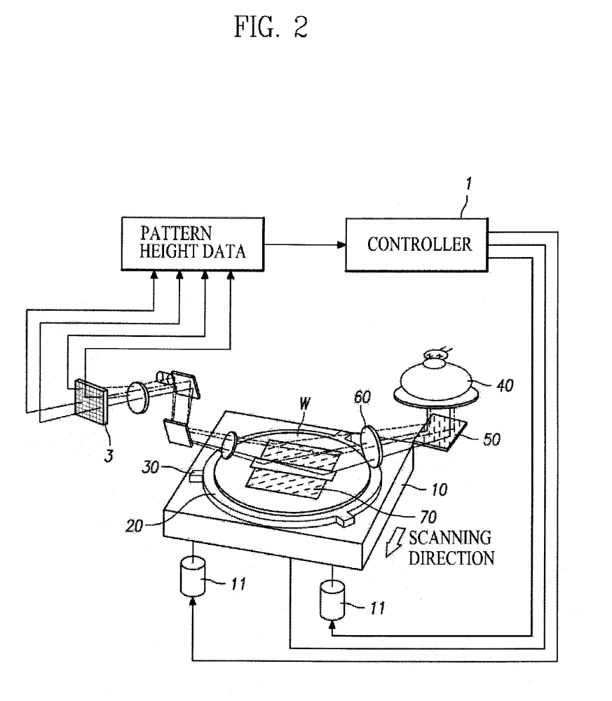

Example FIG. 2 is a perspective view showing the operation of the auto focus system according to the embodiments.

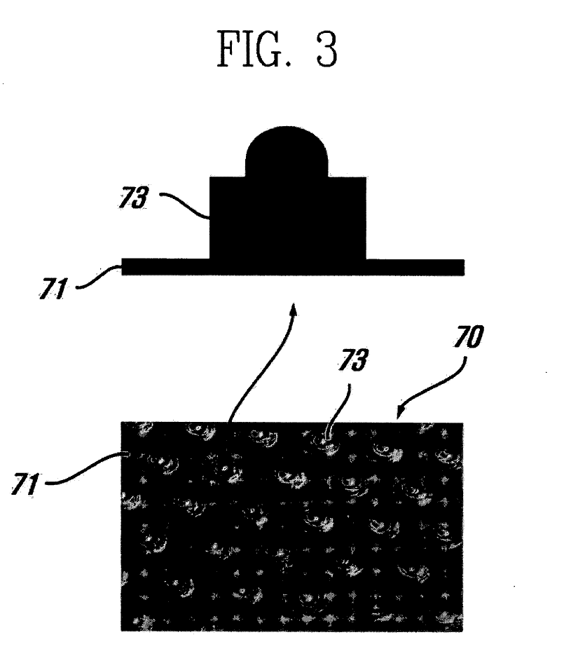

Example FIG. 3 is an enlarged view showing a piezo of the auto focus system according to embodiments.

### DESCRIPTION

Embodiments of an auto focus system will be described with reference to accompanying drawings. Example FIG. 1 is a schematic view showing an auto focus sensor block of an auto focus system according to embodiments. Example FIG. 2 is a perspective view showing an operating state of the auto focus system according to embodiments. Example FIG. 3 is an enlarged view showing a piezo of the auto focus system according to embodiments.

Referring to example FIGS. 1 to 3, the auto focus system is constituted by a wafer stage 10, a wafer holder 20, a focus control unit 30, a light source system 40, a reflective mirror 50, and reticle 60. The wafer stage 10 is moved by means of an actuator 11 operated by a controller 1. The wafer holder 20 is installed in the upper side of the wafer stage 10, and a wafer is fixed over the upper surface of the wafer holder.

Pins 73 are mounted on the upper surface of the wafer holder 20 to correspond to a pitch in which auto focus sensors of an auto focus sensor block are disposed. The piezo 70 capable of moving the wafer (W) up and down by means of the contraction and expansion of the pins 73 is attached thereon.

When light is irradiated, defocusing data is ascertained through the auto focus sensor block 3 using the light transferred to the controller 1. The controller 1 operates the piezo 50 by controlling the contraction and expansion of the pins 73 corresponding to the respective auto focus sensors of the auto focus sensor block 3. That is, embodiments roughly control the focus by means of an existing focus system disposed in a triangle, and secondly use the pins 73 mounted on the piezo 70, thereby finely controlling defocus due to particles and defocus generated due to a step in the wafer.

The piezo 70 is constituted by a base plate 71 in a rectangular shape, and cylindrical pins 73 provided at regular intervals on the upper surface of the base plate 71. The upper surface center portions of pins 73 are expanded or contracted according to an electrical signal applied from the controller 1. The wafer (W) is mounted over the upper surface of the piezo 70, and is finely moved up and down over the wafer holder by means of the expansion and contraction of pins 73.

The focus control unit 30 is provided at equal distances on the outer surface of the wafer holder 20 to drive the wafer holder 20 up and down. According to embodiments, three focus control units may be installed at equal distances.

The light source system 40 may be provided at one side of the wafer stage 10 to irradiate the wafer (W). The light from the light source system 40 may be directed to the wafer (W) using a reflective mirror 50.

The reflective mirror 50 is provided below the light source system 40. The light irradiated to the wafer (W) is transmitted through the reticle 60 by means of reflective mirror 50. The reticle has a pattern formed in a predetermined shape so that the pattern may be fixed to the wafer (W).

As described above, with the auto focus system according to embodiments, a defocus due to the step generated at the edge portion of the wafer and defocus due to the particles adhered to the back surface of the wafer are effectively controlled, thereby making it possible to cleanly expose the pattern without having a defocus.

It will be obvious and apparent to those skilled in the art that various modifications and variations can be made in embodiments. Thus, it is intended that the disclosed embodiments cover the obvious and apparent modifications and variations, provided that they are within the scope of the appended claims and their equivalents.

What is claimed is:

1. An apparatus comprising:
a wafer holder;
an auto focus sensor block comprising a plurality of auto focus sensors for measuring a focus of a wafer;
a piezo actuator including pins corresponding to the auto focus sensors and capable of moving a wafer up and down by driving the pins.

2. The apparatus of claim 1, wherein said piezo actuator uses focus data from the auto focus sensor block to determine the movement of the pins.

3. The apparatus of claim 1, wherein said piezo actuator is capable of actuating the movement of at least one individual pin independently of at least one other individual pin.

4. The apparatus of claim 1, comprising a wafer stage movable in all directions by an actuator.

5. The apparatus of claim 4, wherein said wafer holder is installed on the upper side of the wafer stage.

6. The apparatus of claim 5, wherein said piezo is positioned on an upper surface of said wafer holder.

7. The apparatus of claim 1, wherein said auto focus sensor block measures a focus of a wafer simultaneously with an exposure.

8. The apparatus of claim 1, comprising focus control units to drive the wafer holder up and down.

9. The apparatus of claim 8, wherein said focus control units are provided at equal distances on an outer surface of the wafer holder.

10. The apparatus of claim 4, comprising a light source system provided at one side of the wafer stage to irradiate light on the wafer.

11. The apparatus of claim 10, comprising a reflective mirror provided below the light source system so that the light irradiated from the light source system is directed to the wafer.

12. The apparatus of claim 11, comprising a reticle passing the light so that a pattern is applied to the wafer by the light irradiated from the light source system.

13. The apparatus of claim 1, wherein the piezo comprises:
a base plate; and
pins provided at regular intervals on the upper surface of the base plate.

14. The apparatus of claim 13, wherein an upper surface and a center portion of the pins are expanded or contracted according to an external electrical signal.

15. The apparatus of claim 1, wherein the pins are disposed to have a pitch conforming to the pitch of the auto focus sensors.

16. A method comprising:
mounting a wafer on a piezo actuator mounted on a wafer holder;
measuring a focus of the wafer using an auto focus sensor block comprising a plurality of auto focus sensors;
moving subportions of the wafer up and down by driving pins on said piezo actuator, said pins corresponding to said auto focus sensors.

17. The method of claim 16, wherein said piezo actuator uses focus data from the auto focus sensor block to determine movement of the pins.

18. The method of claim 17, wherein said piezo actuator actuates the movement of individual pins independently.

19. The method of claim 16, wherein the wafer holder is mounted on a wafer stage movable in all directions by an actuator.

20. The method of claim 16, wherein said auto focus sensor block measures a focus of the wafer simultaneously with an exposure.
